(19) United States
(12) Patent Application Publication
(10) Pub. No.: US 2015/0381445 A1
(43) Pub. Date: Dec. 31, 2015

(54) RETAINING SERVICE CONFIGURATION DURING TEST CONNECTION

(71) Applicants: Alcatel-Lucent Canada, Inc., Ottawa (CA); Alcatel Lucent, Boulogne Billancourt (FR)

(72) Inventors: Matthew Bocci, London (GB); Shafiq Pirbhai, Ottawa (CA); David Motz, Ottawa (CA); Brad Forden, Ottawa (CA)

(21) Appl. No.: 14/319,139

(22) Filed: Jun. 30, 2014

(51) Int. Cl. H04L 12/26; H04W 24/08

(52) U.S. Cl. CPC H04L 43/0811; H04L 43/50; H04W 24/08

(57) ABSTRACT

A method for retaining service configuration during test connection to a pseudowire service is disclosed. The method for retaining service configuration during test connection includes the steps of configuring a test service access point; providing a first instruction at a first network element to lock the pseudowire connection; providing a second instruction at a second network element to lock the pseudowire connection; receiving an instruction at said the network element to associate a test service provided at a network management element to said first Service Distribution Point; and providing a loopback instruction to the pseudowire connection. The method for retaining service configuration during test connection to a pseudowire service provides advantages over systems known in the art by eliminating the need for reconfiguring the connection to customer equipment at the point of test and afterwards.

### FIELD OF THE INVENTION

The invention relates to testing customer connections and is particularly concerned with making connections to a customer service while minimizing reconfigurations.

### BACKGROUND OF THE INVENTION

An important test and diagnostic capability in transport networks is to be able to perform an on-demand test of the throughput and performance of a path, which can also be used to help localize faults. This is achieved by taking the path out of service, creating a data path loopback at some node along the path, up to where the test needs to be performed, and sending test data along the path. The test data would typically be generated and collected by a separate test generator/analyzer set at one end of the path. This enables the connectivity and performance of a path to be tested from a single, centralized location.

The RFC6435 standard specifies a standardized mechanism for locking a pseudowire (PW) and creating a data path loopback. It defines lock instruct messages and loopback configuration. In order to conduct an out-of-service throughput test, an label switched path (LSP) or PW is administratively locked either by the operator from the command line interface network management system (CLI/NMS) at both maintenance end points (the ends of the PW or LSP), or by one maintenance entity group end point (MEP) sending a lock instruct to the far end MEP. The lock instruct message is carried in a Generic Associated Channel (G-Ach) on Channel 0x0026. The LSP or PW may then be put into loopback mode (for two way tests) so that the ingress data path in the forward direction is cross connected to the egress data path in the reverse direction of the LSP or PW by the source MEP sending a loopback request to a maintenance entity group intermediate point (MIP) or the far-end MEP. The loopback is configured through CLI or NMS. Note that in the case of a PW, a loopback is created at the PW level. That is, everything under the PW label is looped back.

The problem with this solution is that it results in all user traffic on the PW being dropped, and it does not provide a solution for how to inject test traffic into the PW. The implementer is left to assume that the customer equipment connecting to one MEP should be disconnected from the system under test, and a test traffic generator connected. This is labor intensive and may be disruptive to a traffic originating or terminating on the customer equipment. Further, upon completion of any testing activity, the customer equipment will have to be reconfigured to the pseudowire so that service may be restored.

Therefore, it would be useful to have a method which could facilitate the connection of test equipment to a pseudowire while simplifying both configuration of the test equipment and reconfiguration of customer equipment at test completion in an IP/MPLS network.

### SUMMARY OF THE INVENTION

It is an object of the invention to provide a method which facilitates the connection of test equipment to a pseudowire while simplifying both configuration of the test equipment and reconfiguration of customer equipment at test completion in an IP/MPLS network.

According to a first aspect of the invention there is provided a method of connecting to a pseudowire connection between a first Service Distribution Point located at a first network element and a second Service Distribution Point located at a second network element, the method having the steps of: configuring a test service access point; providing a first instruction at the first network element to lock the pseudowire connection; providing a second instruction at the second network element to lock the pseudowire connection; receiving an instruction at said the network element to associate a test service provided at a network management element to said the Service Distribution Point; and providing a loopback instruction to the pseudowire connection.

In some embodiments of this aspect of the invention the loopback instruction is provided to a Maintenance Entity Group End Point. In other embodiments of this aspect of the invention the loopback instruction is provided to a Maintenance Entity Group Intermediate Point.

In other embodiments of the invention a Service Access Point connected to said first Service Distribution Point is connected to a backup Service Distribution Point subsequent to said first instruction.

In yet other embodiments of the invention a Service Access Point connected to said second Service Distribution Point is connected to a backup Service Distribution Point subsequent to said second instruction.

Note: in the following the description and drawings merely illustrate the principles of the invention. It will thus be appreciated that those skilled in the art will be able to devise various arrangements that, although not explicitly described or shown herein, embody the principles of the invention and are included within its spirit and scope. Furthermore, all examples recited herein are principally intended expressly to be only for pedagogical purposes to aid the reader in understanding the principles of the invention and the concepts contributed by the inventor(s) to furthering the art, and are to be construed as being without limitation to such specifically recited examples and conditions. Moreover, all statements herein reciting principles, aspects, and embodiments of the invention, as well as specific examples thereof, are intended to encompass equivalents thereof.

### BRIEF DESCRIPTION OF THE DRAWINGS

The present invention will be further understood from the following detailed description of embodiments of the invention, with reference to the drawings in which like reference numbers are used to represent like elements, and:

FIG. 1 illustrates an exemplary pair of network edge switches connected through a tunneling protocol according to the prior art;

FIG. 2 illustrates an exemplary test service connection according to an embodiment of the invention; and

FIG. 3 illustrates a block diagram of a network equipment processor assembly according to an embodiment of the invention.

### DETAILED DESCRIPTION

In the following description, numerous specific details are set forth. However, it is understood that embodiments of the invention may be practiced without these specific details. In other instances, well-known circuits, structures and techniques have not been shown in detail in order not to obscure the understanding of this description. It will be appreciated, however, by one skilled in the art that the invention may be practiced without such specific details. In other instances, control structures, gate level circuits and full software instruction sequences have not been shown in detail in order not to obscure the invention. Those of ordinary skill in the art, with the included descriptions, will be able to implement appropriate functionality without undue experimentation.

References in the specification to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such a feature, structure, or characteristic in connection with other embodiments whether or not explicitly described.

In the following description and claims, the terms “coupled” and “connected,” along with their derivatives, may be used. It should be understood that these terms are not intended as synonyms for each other. “Coupled” is used to indicate that two or more elements, which may or may not be in direct physical or electrical contact with each other, cooperate or interact with each other. “Connected” is used to indicate the establishment of communication between two or more elements that are coupled with each other.

The techniques shown in the figures can be implemented using code and data stored and executed on one or more electronic devices (e.g., a network element). Such electronic devices store and communicate (internally and with other electronic devices over a network) code and data using machine-readable media, such as machine storage media (e.g., magnetic disks; optical disks; random access memory; read only memory; flash memory devices) and machine communication media (e.g., electrical, optical, acoustical or other form of propagated signals—such as carrier waves, infrared signals, digital signals, etc.). In addition, such electronic devices typically include a set of one or more processors coupled to one or more other components, such as a storage device, one or more user input/output devices (e.g., a keyboard and/or a display), and a network connection. The coupling of the set of processors and other components is typically through one or more busses and bridges (also termed as bus controllers). The storage device and signals carrying the network traffic respectively represent one or more machine storage media and machine communication media. Thus, the storage device of a given electronic device typically stores code and/or data for execution on the set of one or more processors of that electronic device. Of course, one or more parts of an embodiment of the invention may be implemented using different combinations of software, firmware, and/or hardware.

As used herein, a network element (e.g., a router, switch, bridge, etc.) is a piece of networking equipment, including hardware and software that communicatively interconnects other equipment on the network (e.g., other network elements, computer end stations, etc.). Customer computer end stations (e.g., workstations, laptops, palm tops, mobile phones, etc.) access content/services provided over the Internet and/or content/services provided on associated networks such as the Internet. The content and/or services are typically provided by one or more server computing end stations belonging to a service or content provider, and may include public webpages (free content, store fronts, search services, etc.), private webpages (e.g., username/password accessed webpages providing email services, etc.), corporate networks over VPNs, etc. Typically, customer computing end stations are coupled (e.g., through customer premise equipment coupled to an access network, wirelessly to an access network) to edge network elements, which are coupled through core network elements of the Internet to the server computing end stations.

In general in the description of the figures, like reference numbers are used to represent like elements.

In transport networks as described herein, a service is a globally unique entity that refers to a type of connectivity service for either Internet or VPN connectivity. Each service may be uniquely identified by a service ID within a service area. The network elements service model as described herein uses logical service entities to construct a service. In the service model, logical service entities provide a uniform, service-centric configuration, management, and billing model for service provisioning.

Services can provide Layer 2/bridged service or Layer 3/IP routed connectivity between a service access point (SAP) on one network element and another service access point (a SAP is where traffic enters and exits the service) on the same (local) or another network element (distributed). A distributed service spans more than one network element. Typically a SAP is the point of connection for customer equipment.

Distributed services use service distribution points (SDPs) to direct traffic to another network element through a service tunnel. SDPs are created on each participating network element, specifying the origination address (the network element participating in the service communication) and the destination address of another network element. SDPs are then bound to a specific customer service. Without the binding process, far-end network element devices are not able to participate in the service (there is no service without associating an SDP with a service).

A VPLS-capable network consists of Customer Edges (CE), Provider Edges (PE), and a core MPLS network. The CE connects to the PE via Service Access Points (SAP). The PE sets up the VPN and tunnels traffic inside the LSP/PW according to the bindings of the service definition. The MPLS labels are designated via LDP signaling and forwarded into the MPLS uplink (network interface) towards the core. The IP/MPLS core network interconnects the PEs but does not participate in the VPN functionality. Traffic is simply switched based on the MPLS labels.

Service Manager

A Service Manager implementation of VLL makes use of a service-based architecture that provides the following logical entities that are required to provision a service:

Customers (subscribers). An account is created for each customer and assigned an ID. The customer ID is required and associated with the service at the time the service is created.

Service Access Points (SAPs). Each subscriber service type is configured with at least one SAP. A SAP identifies the point at which customer traffic enters the service.

Service Distribution Points (SDPs). A SDP provides a logical point at which customer traffic is directed from one PE to another PE through a one-way service tunnel.

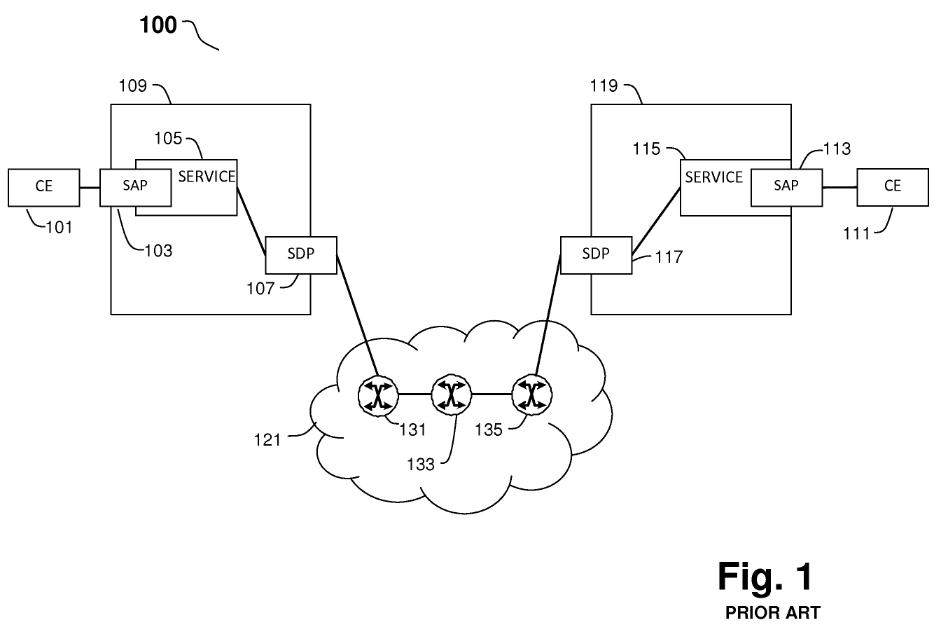

Referring now to FIG. 1 wherein there may be seen an exemplary network 100 having provider edge network elements 109 and 119. Connected to provider edge network element 109 via Service Access Point 103 is customer equipment 101. Also connected to provider edge network element 109 via Service Access Point 104 is customer equipment 102. Service Access Point 103 is associated with service 105. This service could be, by way of example, Virtual Leased Line (VLL) services; Virtual Private LAN Service (VPLS) as in a Layer 2 multipoint-to-multipoint VPN; Internet Enhanced Service (IES) as in a direct Internet access service where the customer is assigned an IP interface for Internet connectivity; Virtual Private Routed Network (VPRN) as in a Layer 3 IP multipoint-to-multipoint VPN service as defined in RFC 2547bis; or a Circuit Emulation Service (Cpipe)—circuits encapsulated in MPLS which use circuit pipes (Cpipes) to connect to the far end circuit. Cpipes support either SAP-Spoke SDP or SAP-SAP connections. Likewise Service Access Point 104 is associated with service 106.

At the other end of this exemplary network, there may be seen customer equipment 111 connected to provider edge network element 119 via Service Access Point 113. As well there may be seen customer equipment 112 connected to provider edge network element 119 via Service Access Point 114. Service Access Point 113 is associated with service 115 and Service Access Point 114 is associated with service 116. Connection across core network 121 occurs via data tunnels through MEP 131, MIP 133, and MEP 135.

When service 105 needs to be communicatively connected across the core network 121 to one of the services in provider edge network element 119, an association between service 105 and Service Distribution Point 107 is established. Similarly, when service 115 needs to be communicatively connected across the core network 121 to one of the services in provider edge network element 109, an association between service 115 and Service Distribution Point 117 is established.

As disclosed above, the RFC6435 standard specifies a standardized mechanism for locking a pseudowire (PW) and creating a data path loopback. It defines lock instruct messages and loopback configuration. In order to conduct an out-of-service throughput test, an label switched path (LSP) or PW is administratively locked either by the operator from the command line interface network management system (CLI/NMS) at both maintenance end points (the ends of the PW or LSP), or by one maintenance entity group end point (MEP) sending a lock instruct to the far end MEP. The lock instruct message is carried in a Generic Associated Channel (G-Ach) on Channel 0x0026. The LSP or PW may then be put into loopback mode (for two way tests) so that the ingress data path in the forward direction is cross connected to the egress data path in the reverse direction of the LSP or PW by the source MEP sending a loopback request to a maintenance entity group intermediate point (MIP) or the far-end MEP. The loopback is configured through CLI or NMS. Note that in the case of a PW, a loopback is created at the PW level. That is, everything under the PW label is looped back.

The problem with this solution is that it results in all user traffic on the PW being dropped, and it does not provide a solution for how to inject test traffic into the PW. The implementer is left to assume that the customer equipment connecting to one MEP should be disconnected from the system under test, and a test traffic generator connected. This is labor intensive and may be disruptive to a traffic originating or terminating on the customer equipment. Further, upon completion of any testing activity, the customer equipment will have to be reconfigured to the pseudowire so that service may be restored.

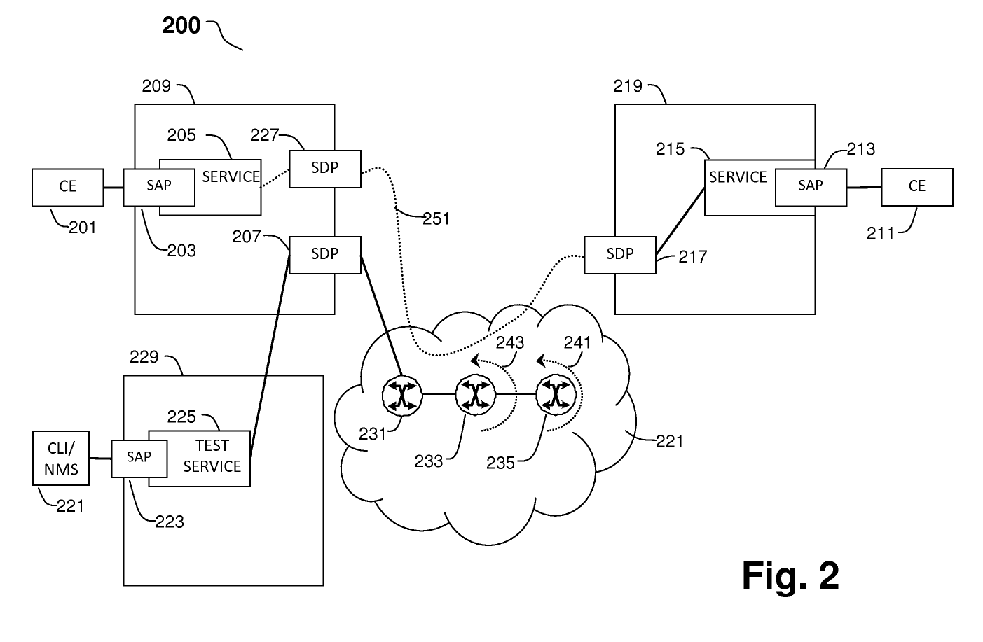

Referring now to FIG. 2, there may be seen an exemplary network according to an embodiment of the invention. Referring to FIG. 2 there may be seen an exemplary network having provider edge network elements 201 and 211. Network element 201 has a PW service 205 normally associated with Service Distribution Point (SDP) 207. Likewise, network element 211 has a PW service 215 associated with SDP 217.

Referring again to FIG. 2, there may be seen a network element 229 containing a Test Service 225. Test service 225 is associated with SAP 223 on which CLI/NMS 221 is connected. In operation the PW through MEP 231, MIP 233, and MEP 235 is administratively locked by locking the host service using the admin-lock flag in a tools command. This command is executed at both ends of the PW or MS-PW. Test traffic is then injected into the PW using a SAP (the ‘test SAP’), defined by the Test Service 225. The test service is identified in the tools command at one end of the locked PW. When admin-lock is configured on a PW, all traffic is forwarded to/from Test SAP 223 defined in test service 225, which must be of a type that is compatible with the PW. Traffic to/from a non test-SAP 203 is dropped. If no test-SAP is defined, then all traffic received on the PW is dropped, and all traffic received on the mate SAP 213 is also dropped. Such an admin-locked PW is treated as operationally down.

If PW redundancy is configured (by configuring more than one PW in the endpoint group), then customer traffic can switch over from the PW that is currently under lock to another PW that is not currently under lock. Referring to FIG. 2 there may be seen backup SDP 227 connecting via backup PW 251 to SDP 217, thus preserving customer traffic flow.

In operation a Test Service will only have 1 test SAP configured via CLI/SNMP, and will come operationally up as soon as it is associated with a PW. The loop back function of RFC6435 can then be invoked the MEPs and MIPs of the PW. By way of example, on MIP 233 at shown at loopback 241, or MEP 235 at loopback 243. Once the command is triggered from management interface (CLI/SNMP) to associate the customer PW to Test Service 225 with SAP 223, the datapath is re-programmed so that the PW receives/sends traffic from/to the Test SAP 223. However, the original SAP 203 is not disconnected from the customer equipment 201, and no changes are made to the original SAP 2013 or the way that it is configured as would be required were a manual test analyzer to be connected as practiced in the previous art.

Thus, there is no need to deconfigure and reconfigure customer services and PWs every time a customer PW needs to be tested. Embodiments of the present invention allow the ease of associating a test service SAP with a customer PW without the need to tear down configuration every time a new customer PW is to be tested.

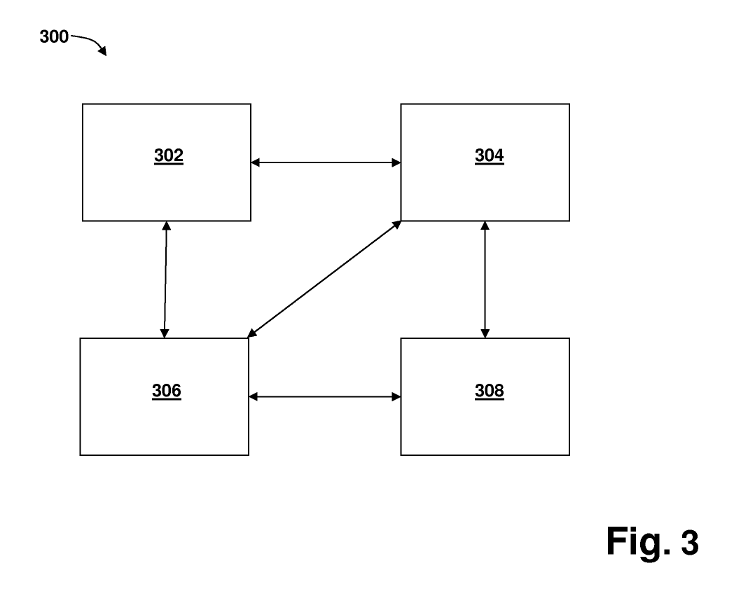

Referring now to FIG. 3, a network equipment processor assembly 300 which in certain embodiments may be used in the handling of packets, includes a network equipment processor element 306 (e.g., a central processing unit (CPU) and/or other suitable processor(s)), a memory 308 (e.g., random access memory (RAM), read only memory (ROM), and the like), a cooperating module/process 302, and various input/output devices 304 (e.g., a user input device (such as a keyboard, a keypad, a mouse, and the like), a user output device (such as a display, a speaker, and the like), an input port, an output port, a receiver, a transmitter, and storage devices (e.g., a tape drive, a floppy drive, a hard disk drive, a compact disk drive, and the like)).

It will be appreciated that the functions depicted and described herein may be implemented in hardware, for example using one or more application specific integrated circuits (ASIC), and/or any other hardware equivalents. Alternatively, according to one embodiment, the cooperating process 302 can be loaded into memory 308 and executed by network equipment processor 306 to implement the functions as discussed herein. As well, cooperating process 302 (including associated data structures) can be stored on a tangible, non-transitory computer readable storage medium, for example magnetic or optical drive or diskette, semiconductor memory and the like.

It is contemplated that some of the steps discussed herein as methods may be implemented within hardware, for example, as circuitry that cooperates with the network equipment processor to perform various method steps. Portions of the functions/elements described herein may be implemented as a computer program product wherein computer instructions, when processed by a network equipment processor, adapt the operation of the network equipment processor such that the methods and/or techniques described herein are invoked or otherwise provided. Instructions for invoking the inventive methods may be stored in fixed or removable media, and/or stored within a memory within a computing device operating according to the instructions.

Therefore what has been disclosed is a method for selectively connecting a PW connection to a test service SAP without the need for configuration and reconfiguration of the Service Access Point that the Customer Equipment normally connects to.

Note, in the preceding discussion a person of skill in the art would readily recognize that steps of various above-described methods can be performed by appropriately configured network processors. Herein, some embodiments are also intended to cover program storage devices, e.g., digital data storage media, which are machine or computer readable and encode machine-executable or computer-executable programs of instructions, wherein said instructions perform some or all of the steps of said above-described methods. The program storage devices are all tangible and non-transitory storage media and may be, e.g., digital memories, magnetic storage media such as a magnetic disks and magnetic tapes, hard drives, or optically readable digital data storage media. The embodiments are also intended to cover network element processors programmed to perform said steps of the above-described methods.

Numerous modifications, variations and adaptations may be made to the embodiment of the invention described above without departing from the scope of the invention, which is defined in the claims.

What is claimed is:

1. A method of connecting to a pseudowire connection between a first Service Distribution Point located at a first network element and a second Service Distribution Point located at a second network element, the method comprising the steps of:
configuring a test service access point;
providing a first instruction at said first network element to lock the pseudowire connection;
providing a second instruction at said second network element to lock the pseudowire connection;
receiving an instruction at said first network element to associate a test service provided at a network management element to said first Service Distribution Point; and
providing a loopback instruction to said pseudowire connection.

2. A method as claimed in claim 1 wherein
said loopback instruction is provided to a Maintenance Entity Group End Point.

3. A method as claimed in claim 1 wherein
said loopback instruction is provided to a Maintenance Entity Group Intermediate Point.

4. A method as claimed in claim 2 wherein
a Service Access Point connected to said first Service Distribution Point is connected to a backup Service Distribution Point subsequent to said first instruction.

5. A method as claimed in claim 3 wherein
a Service Access Point connected to said second Service Distribution Point is connected to a backup Service Distribution Point subsequent to said second instruction.
